(19) United States
(12) Patent Application Publication
(10) Pub. No.: US 2002/0010585 A1
(43) Pub. Date: Jan. 24, 2002

(54) System for the voice control of a page stored on a server and downloadable for viewing on a client device

(75) Inventors: Bruno Gachie, Lille (FR); Anselme Dewavrin, Halluin (FR)

Correspondence Address: WEINGARTEN, SCHURGIN, GAGNEBIN, & HAYES, LLP, TEN POST OFFICE SQUARE, BOSTON, MA, 02109, US

(73) Assignee: INTERACTIVE SPEECH TECHNOLOGIES

(21) Appl. No.: 09/756,418

(22) Filed: Jan. 8, 2001

(30) Foreign Application Priority Data
Jun. 8, 2000 (FR) 00 07359

(51) Int. Cl. G10L 11/00

(52) U.S. Cl. 704/270.1

(57) ABSTRACT

The system permits the voice control of a page intended to be displayed on a client device (2) which, on one hand, can exchange data with a remote server (1) via a telecommunications network (3) and which, on the other hand, includes means (11, 12) permitting the recording of a voice command spoken by a user, and voice recognition means making it possible, from a recorded voice command, to determine and command automatically the execution of an action associated with this voice command. The server (1) has in its memory, in association with said page (page (1).htm, . . . ), at least one dictionary (page (1).ias, . . . ) of one or more voice links including for each voice link at least one audio recording of the voice command; the client device is capable of downloading into its memory each dictionary associated with the page, and the voice recognition means of the client device (2) comprise a voice recognition program (E) that is designed to make a comparison of the audio recording corresponding to the voice command with the audio recording or recordings of each dictionary associated with the page.

The present invention relates to voice control of pages accessible on a server via a telecommunications network and, more especially, of hypertext pages. It will find an application primarily, but not exclusively, in voice-controlled hypertext navigation on an Internet type telecommunications network.

In the present text, the term “server” generally refers to any data processing system in which data is stored and which can be remotely consulted via a telecommunications network.

The term “page” denotes any document designed to be displayed on a screen and stored on a server site at a given address.

The term “client device” generally refers to any data processing device capable of sending requests to a server site so that the latter sends it, in return, the data concerned by the request, and, in particular, a given page, for example one identified in the request by its address on the server.

The term “telecommunications network” generally refers to any means of communication permitting the remote exchange of data between a server site and a client device; it can be a local area network (LAN) such as the intranet, or internal network, of a company, or again, a wide area network (WAN) such as, for example, the Internet network, or yet again, a group of networks of different types that are interconnected.

To simplify the remote transmission of pages between a server and a client device connected to this server via a telecommunications network, use is commonly made of hypertext navigation systems which make it possible to navigate among a number/set of pages connected to one another by links, also known as hypertext links, or hyperlinks. In practice, in a hypertext navigation system, a hypertext page contains, in addition to the basic text to be displayed on the screen, special characters and sequences of characters which may or may not form an integral part of the basic text, and which constitute the hypertext links of the page. When these hypertext links form an integral part of the basic text of the page, they are differentiated from the other characters of the basic page, for example by being underlined and/or displayed in another colour, etc. To manage hypertext navigation, the client device is usually equipped with navigation software, also called a navigator. When the user selects a hypertext link in the page currently displayed, the navigation software, in the first place, automatically establishes and sends the server a request, enabling the latter to send the page associated with the hypertext link that has been selected, and, subsequently, displays on the screen the new page sent to it by the server.

In order to make it easier to activate the hypertext links in a hypertext navigation system, there have already been proposed systems for activation by voice control, in which the hypertext link is spoken by the user, and is automatically recognised by a voice recognition system. These voice activation systems advantageously replace the traditional manual (keyboard/mouse) activation systems, and even prove essential in all applications in which it cannot be contemplated making use of a manual tool such as a keyboard or a mouse, or it is not wished to do so. One example of this type of application is voice navigation on the world network Internet by means of WAP mobile telephones.

To date, the systems for voice activation of links in a hypertext page are essentially based on an automatic analysis (“parsing”) of the hypertext page, on automatic detection of the links present on the page, and on the automatic generation of phonemes from each link detected.

More especially, U.S. Pat. No. 6,029,135 discloses a system for hypertext navigation by voice control which can be implemented in two variants: a first, so-called “run-time” variant, and a second, so-called “off-line” variant. In the “off-line” variant, it is taught to cause the hypertext page provider generate “additional data”for the voice control of these pages, which additional data is downloaded from the server together with the hypertext page. This “additional data” is used by the “client” effect voice recognition of the words spoken by a user via a microphone, voice recognition intelligence being located at client level. In the sole form of embodiment described, the “additional data” is constituted by a dictionary of phonemes, associated with a probability model. The dictionary of phonemes and the associated probability model are automatically generated from the page by automatically analysing the contents of the document and automatically retrieving the links present in the document. For this purpose, a dedicated software known as a “manager” is used.

Prior art solutions and, in particular, the one adopted in U.S. Pat. No. 6,029,135, have the major drawback of being based on phonetic recognition which, on one hand, complicates voice recognition, and is a major source of error, and which, on the other hand, necessitates the use of complex software (the “manager”) permitting the automatic translation of each word in the form of phonemes, and the automatic preparation of probability models for implementing phonetic recognition. The phonetic translation software is all the more complex if it is wished, for example, to integrate different pronunciations for a word, to take into account the language. In addition, this type of solution has the drawback of being dependent on a language for automatic transcription of the text of the command into its translation in phonetics. For the reasons given above, these solutions are, to date, relatively costly and only available to highly specialised professional navigation systems, hence little adapted to so-called ‘general public’ applications.

The main object of the present invention is to provide a system that permits voice control of a page that is to be displayed on a client device capable of exchanging data with a remote server via a telecommunications network, and which overcomes the aforementioned drawbacks of the existing systems. Voice control of a page is aimed not only at voice activation of links associated with the page, but also, and more generally speaking, at voice activation of any command associated with the page displayed, the command not necessarily taking the form of a word displayed on the screen of the client device but possibly being hidden. Execution of the command associated with a page can vary in nature and does not limit the invention (activation of a hypertext link referring to a new page on the server, control of the peripherals of the client device such as, for example, a printer, the opening or closing of windows on the client device, disconnection of the client device, connection of the client device to a new server, etc.).

In a manner known, in particular from U.S. Pat. No. 6,029,135, the client device includes means, such as a microphone and an audio acquisition card, permitting the recording of a voice command spoken by a user, and voice recognition means making it possible, on the basis of a recorded voice command, to determine and control automatically the execution of an action associated with this command.

As is characteristic of and essential to the invention, the server has in its memory, linked to said page, at least a dictionary of one or more voice links, including for each voice link at least an audio recording of the voice command; the client device is capable of downloading into its memory each dictionary associated with the page, and the voice recognition means of the client device comprise a voice recognition program that is designed to effect a comparison of the audio recording corresponding to the voice command with the audio recording or recordings of each dictionary associated with the page.

Further characteristics and advantages of the invention will emerge more clearly from the following description of a particular exemplary form of embodiment, which description is given by way of a non-limitative example and with reference to the annexed drawings, wherein:

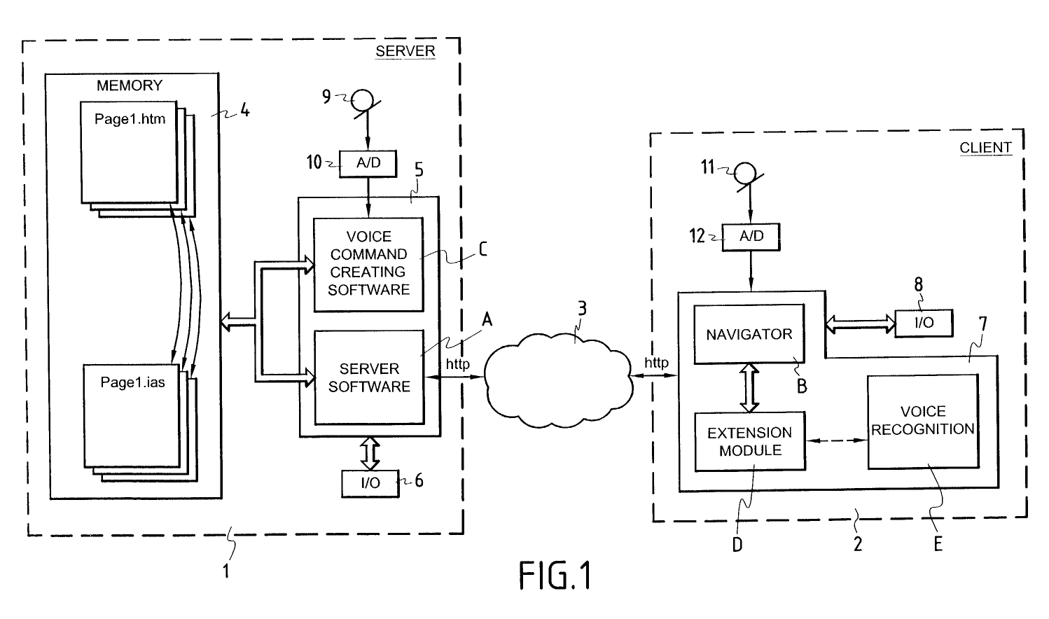

FIG. 1 is a schematic representation of the main items going to make up a voice control system according to the invention;

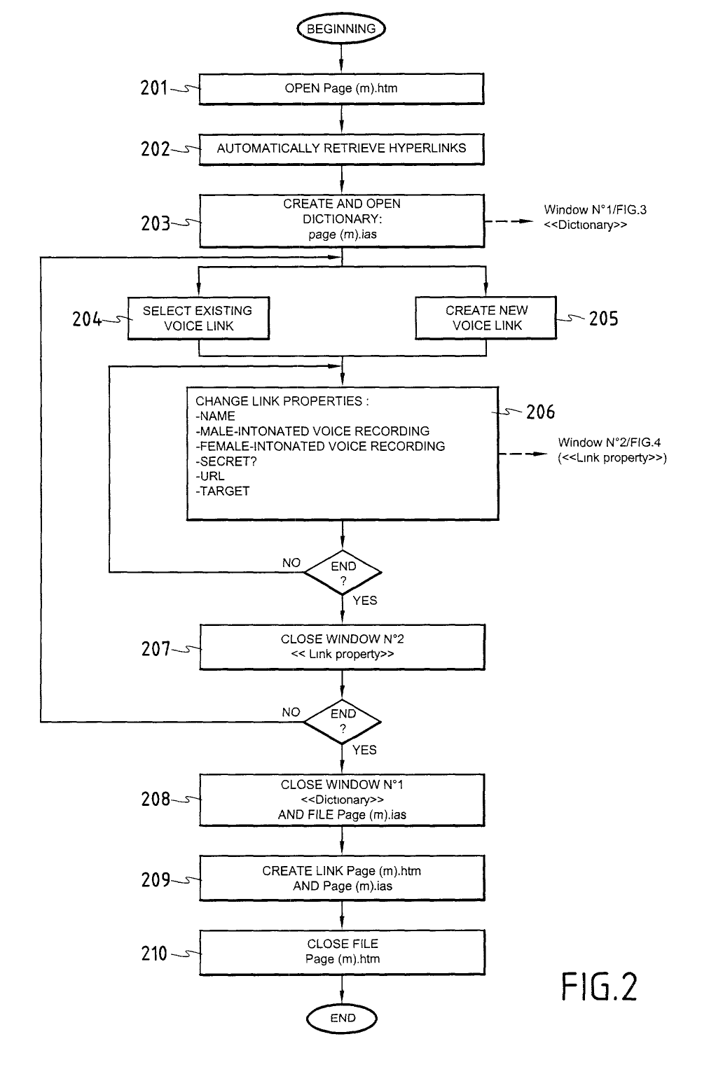

FIG. 2 shows the main steps in a program for help in creating a dictionary of voice links characteristic of the invention and for relating the dictionary created to a page on a server, with a view to voice control of this page;

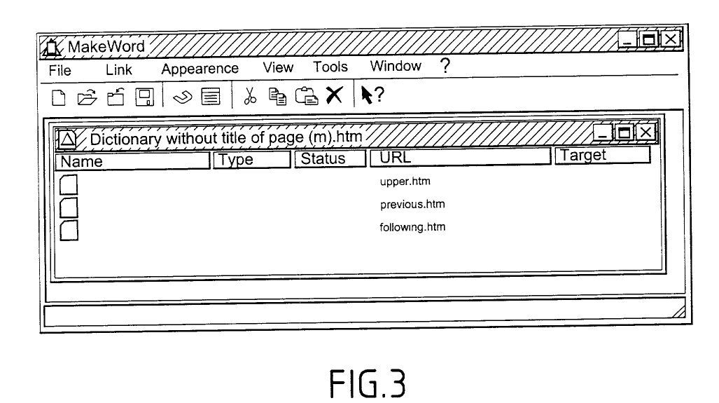

FIGS. 3 to 6 are examples of windows generated by the program for help in creating dictionaries;

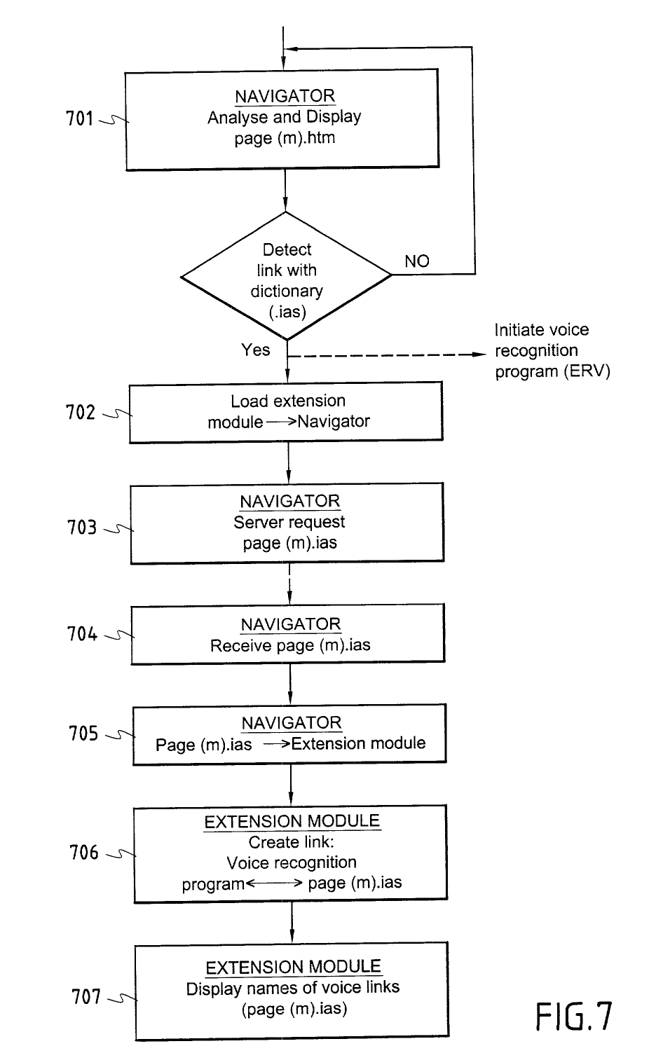

FIG. 7 illustrates the main steps implemented by a client device in at the time of downloading a dictionary associated with a page supplied by a server;

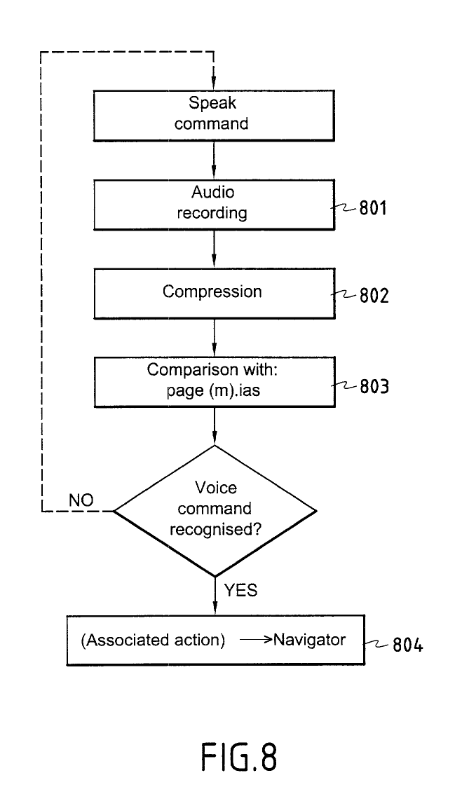

FIG. 8 illustrates the main steps implemented by the voice recognition program run locally by the client device.

With reference to FIG. 1, in a particular exemplary embodiment, the invention implements a data processing server 1, to which one or more client devices can be connected via a telecommunications network 3. More specifically, in the example illustrated, data processing server 1 usually hosts one or more web sites, and the client devices are designed to connect to server 1 via the worldwide network Internet, and to exchange data with this server according to the usual IP communications protocol.

Each web site hosted by server 1 is constituted by a plurality of html pages taking the form of htm format files (FIG. 1, page1.htm, etc.) and interconnected by hyperlinks. These pages are stored in the usual way in a memory unit 4 that is read and write accessible by processing unit 5 of server 1. In addition to memory unit 4 and processing unit 5, server 1 also comprises, in the usual way, input/output means 6, including at least a keyboard enabling an administrator of the server to enter data and/or commands, and at least a screen enabling the server's data and, in particular, the pages of a site, to be displayed. To manage the exchange of data with a client 2 via the network 3, the RAM memory of processing unit 5 comprises server software A, known per se and making it possible, in particular, to send to a client 2 connected to server 1 the file or files corresponding to the client's request.

A client device 2 comprises, in a known manner, a processing unit 7 suitable for connection to network 3 via a communications interface, and also connected to input/output means 8, including at least a screen for displaying each html page sent by server 1. The processing unit uses navigation software B, known per se, also known as a navigator (for example the navigation software known as Netscape).

The invention, the novel means of which will now be described in detail taking a particular exemplary embodiment, is not limited to an application of the Internet type; it can be applied in a more general manner to any client/server architecture regardless of the type of telecommunications network and of the data exchange protocol used. In addition, the client device can equally well be a fixed terminal or a mobile unit such as a mobile telephone of the WAP type, giving access to telecommunications network 3.

The invention is essentially based on the use, for each page of the server with which it is wished to associate a voice control function, at least one dictionary of voice links, which is stored in the memory of server 1 in association with said page, and which has the particularity of containing, for each voice command, at least one audio recording, preferably in compressed form, of the voice command. In the example illustrated in FIG. 1, each html page has associated with it in the memory of server 1 a single dictionary taking the form of a file having the same name as that of the page but with a different extension, arbitrarily designated as “.ias” in the remainder, of the present description. Thus, the hmtl page taking the form of file page1.htm has associated with it, in the memory of server 1, dictionary file page1.ias, etc. According to another variant, it is possible to contemplate associating several dictionaries with one and the same page.

To enable dictionary files (.ias) to be constructed, server 1 is equipped with a microphone 9 connected to an audio acquisition card 10, (known per se), which, generally speaking, enables the analogue signal output by microphone 9 to be converted into digital type information. This audio acquisition card 10 communicates with processing unit 5 of server 1, and enables the latter to acquire via microphone 9 digital type voice recordings in a digital form. Processing unit 5 is further capable of running C-language software specific to the invention, one variant of which will be described hereinafter, and which assists a person creating a web site in constructing dictionaries of voice links.

Similarly, to enable a voice command spoken by the user to be acquired by processing unit 7 of a client device 2, said client device 2 is likewise equipped with a microphone 11 and with an audio acquisition card 12. As explained in detail hereinafter, automatic voice recognition of a voice command spoken by the user of client device 2, in connection with a page being displayed on the screen of client device 2, is effected locally by processing unit 7 of client device 2, after the dictionary file associated with the page being displayed has been downloaded.

Specifications of a Dictionary File (.ias) In one exemplary embodiment, a dictionary file contains one or more voice links recorded one after the other, with each voice link possessing several concatenated attributes:

1. the name (which corresponds to the phonetic word of the voice command that has to be spoken by the user in order to activate the link);

2. the type;

3. the address (more commonly referred to as URL) enabling the resource associated with the voice command to be located on the server;

4. the target (i.e. the name of the window in which the new page is to be displayed);

5. a male-intonated audio recording (also referred to as an ‘acoustic model’);

6. a female-intonated audio recording (also referred to as an ‘acoustic model’); The “type” attribute of a voice link is used, in particular, to specify:

that a voice link is indeed involved, and to differentiate it, for example, from the hyperlinks of an html page not having voice command capability;

whether it is a link the name of which features in the text of the associated page;

whether this link is to be hidden or whether, on the contrary, the name of the link can be displayed on the screen of client device 2 in a specific window containing, for the user's benefit, the names of all the (non-hidden) links that he/she can voice activate. More particularly, by way of example, in C⁺⁺ language, a voice link can be transcribed as follows:

| | | Size in | Maximum | Permissible |
|---|---|---|---|---|
| Information | type C | bytes | size | values |
| Link type | DWORD | 4 | 4 | See below |
| Name size | short | 2 | 2 | positive number |
| Name | chars | name size | 200 | ANSI characters |
| Size of URL link | short | 2 | 2 | positive number |
| URL | chars | size of | 2048 | ANSI characters |
| | | URL link | | |
| Target size | short | 2 | 2 | positive number |
| Target | chars | target size | 200 | ANSI characters |
| Size of male | short | 2 | 2 | positive number |
| acoustic model | | | | |
| Male acoustic | chars | size of | 2048 | all |
| model | | model | | |
| Size of female | short | 2 | 2 | positive number |
| acoustic model | | | | |
| Female acoustic | chars | size of | 2048 | all |
| model | | model | | |

Program for constructing a dictionary file (FIG. 2)

The main steps in the program for creating a dictionary file will now be explained with reference primarily to FIG. 2. In the example provided in FIG. 1, this program is run by processing unit 5 of the server, after the server's administrator has chosen the corresponding option enabling the program to be initiated. However, in another application, this program can advantageously be made available to the creator of a web site, by being implemented on a machine other than the server, the dictionary files (.ias) created using this program, as well as the pages of the web sites then being uploaded into memory unit 4 of server 2.

With reference to FIG. 2, the creation of a dictionary file page (m).ias associated with an html page begins (step 201) with the opening of the file page (m).htm of the page, followed by automatic retrieval of the hyperlinks present on the page (step 202) and the creation of a dictionary file page(m).ias, with the opening of a display window and modification and/or entry of voice links of this dictionary (“Dictionary” window/step 203). FIG. 3 shows an example of a window created as a result of step 203. In this example, three hyperlinks have been detected and retrieved from page(m).htm and, for each of these hyperlinks there has been created automatically, in the associated dictionary page(m).ias, a voice link the address attribute of which contains the URL address of the corresponding hyperlink automatically retrieved in file page (m).htm.

Proceeding from this first window (FIG. 3), it is possible either to select from the window of FIG. 3 a link existing in the dictionary (step 204) or to create a new voice link in the dictionary (step 205) by selecting the appropriate command from a menu managed by the window of FIG. 3.

It should be emphasized here that the function for creating a new voice link advantageously permits the creation of a voice command, which does not necessarily correspond to a hyperlink present on the page and, precisely thanks to this, it affords the possibility of programming a variety of voice commands and, what is more, hidden commands. In addition, the aforementioned automatic retrieval step (step 202) is optional, and springs solely from a desire to facilitate and accelerate the creation of the dictionary, sparing the user the need to create manually in the dictionary the voice links corresponding to hyperlinks on the page and to enter the corresponding URL addresses.

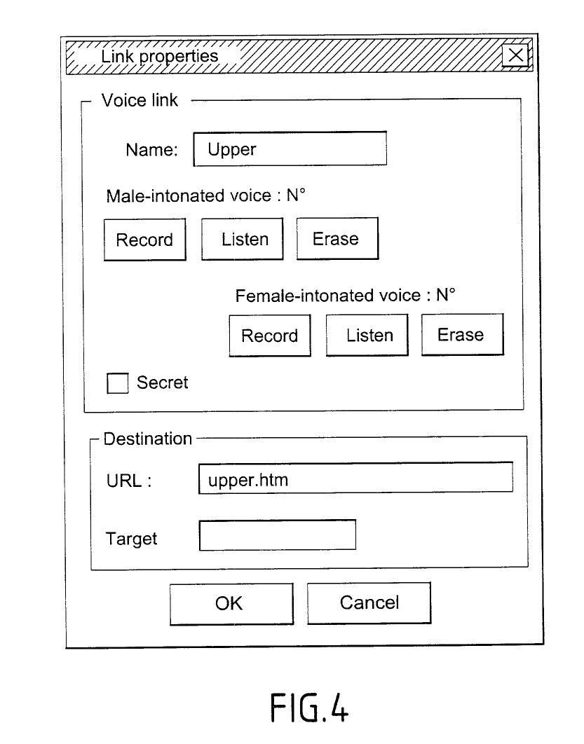

If an existing voice link is selected or a new voice link created, the program opens a second, “link properties”, window of the type illustrated in FIG. 4 (step 206), which enables the user to enter and/or modify the previously described attributes of a voice link.

In particular, in this window, the user can select a first action button, “Record”, to record a voice command spoken by male-intonated voice, and a second action button, “Record”, to record a voice command spoken by a female-intonated voice. When the user selects one of the aforementioned action buttons, the program automatically executes a module for acquiring an audio recording. Once it has been initiated, this module enables an audio recording in the digital form of the voice command (male or female voice as the case may be) to be acquired by microphone 9 for a given, controlled lapse of time, and, following this lapse of time, it automatically compresses this recording using any known data compression process, and then saves this compressed audio recording in dictionary file page(m).ias.

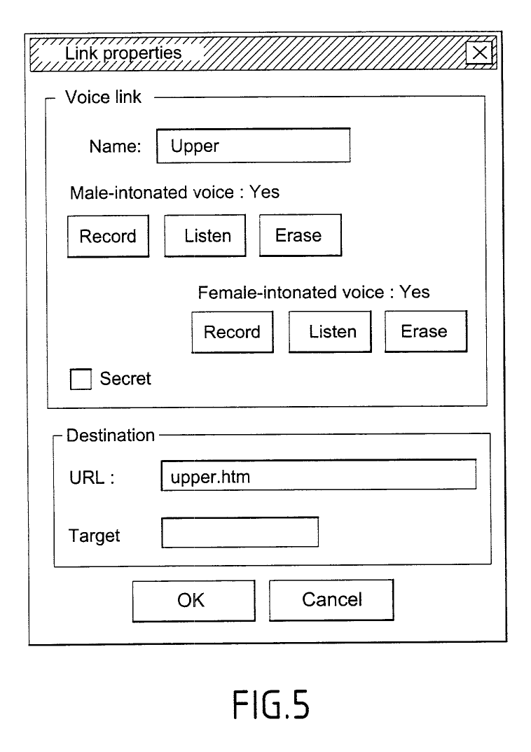

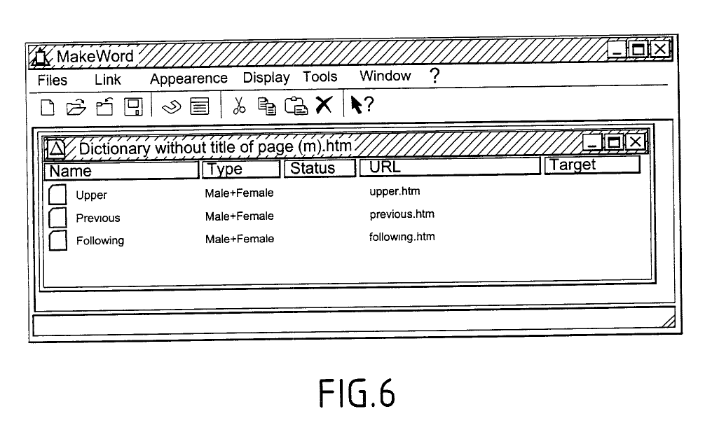

Once the user has validated the fact that all the properties of a voice link have been entered or modified, the program closes the corresponding “link properties” window (step 207) and, once all the voice links in dictionary page (m).ias have been entirely created, the user commands closure of the “Dictionary” window and, by virtue thereof, closure of dictionary page (m).ias (step 208). FIG. 5 provides an example of a “link property” window for the voice link “Upper” updated before the closing of the window; FIG. 6 provides an example of a “Dictionary” window updated prior to closure of dictionary page(m).ias.

Once a dictionary page(m).ias has been fully created, the program automatically creates (step 209) a link between the page (file page(m).htm) and the associated dictionary (file page(m).ias) and closes the dictionary file (page(m).ias). In an alternative embodiment, this link is created by inserting the name (page(m).ias) of the associated dictionary in the file (page(m).htm) of the page. An example of the implementation of the file page(m).htm is given below:

<html>

<head>

<TITLE>(title of the file of the html page)</TITLE>

</head>

<body>

<a href=<following.htm″>Following</a><br>

<a href=<preceding.htm″>Preceding</a><br>

<a href=<upper.htm″>Upper</a><br>

<p><embed src=“page(m).ias″ pluginspage=″″type=application/x-NavigationByVoice″ width=″120″height=″50″></embed></p>

<body>

</hmtl>

The phase of transmission of a dictionary between server 1 and a client device 2, as well as the voice recognition phase, will now be described in detail with reference to FIGS. 1, 7 and 8.

Transmission of a dictionary (.ias)

Initially, with the help of the navigator program (B), client device 2 requests server 1 to send it an html page (for example, file page(m).htm). In the usual way, the navigator (B) analyses file page(m).htm and displays the contents of the page on the screen as and when it receives the data relating to this page (FIG. 7/step 701).

During automatic analysis of file page(m).htm, when the navigator detects the information indicating that a dictionary is attached to this page (detection of src=“page(m).ias″ in the file), it loads an extension module D (FIG. 1) stored in the RAM memory of the client device (step 702) and, in parallel, initiates a voice recognition program also stored in the RAM, in case this program has not been initiated (which is the case, for example, the first time, during a session, a page (.htm) with a dictionary (.ias) attached is received by client device 2).

The navigator then sends server 1 a request (step 703) for the latter to send it the dictionary file page(m).ias identified in file page(m).htm.

After client device 2 has received dictionary file page(m).ias, the navigator (B) of client device 2 sends the dictionary file to the exension module (D) (step 705).

This extension module (D), in its turn, creates a link between dictionary file page(m).ias and the voice recognition program (E) (step 706). Then (step 707), the extension module (D) analyses the contents of dictionary file page(m).ias and displays on the screen, for the user's attention, for example in a new window, the names (“name” attribute) of all the voice links of dictionary file page(m).ias for which the value of the “type” attribute authorises display (non-hidden voice commands (step 706).

Voice recognition This function is provided by the voice recognition program (E), on the basis of a voice command entered by the user by means of microphone 11 and by comparison with the dictionary file or files with which a link has been established. It should be emphasized here that the voice recognition program can be initiated with several extension modules active simultaneously.

More specifically, with reference to FIG. 8, once it has been initiated, the voice recognition program (E) awaits detection of a sound by microphone 11. When the user of the client device speaks a command, this command is automatically recorded in digital form (step 801), and the voice recognition program proceeds to compress this recording, applying the same compression method as that used by the dictionary creating program (C). Then (step 803), the voice recognition program (E) automatically compares the digital data corresponding to this compressed audio recording with the digital data of each compressed audio recording (male and female acoustic recordings) in the dictionary file page(m).ias (or, more generally, in all the dictionary files for which a link with the voice recognition program is active), with a view to deducing therefrom automatically the voice link of the dictionary corresponding to the command spoken by the user.

More specifically, in an alternative embodiment of the invention, each comparison of the compressed audio recordings is carried out using the DTW (Dynamic Time Warping) method and yields, as a result, a mark of recognition characterising the similarity between the recordings. Only the highest mark is then selected by the voice recognition program, and it is compared with a predetermined detection threshold below which it is considered that the word spoken has not been recognised as a voice command. If the highest mark resulting from the aforementioned comparisons is above this threshold, the voice recognition program automatically recognises the voice link corresponding to this mark as being the voice command spoken by the user.

Advantageously according to the invention, as voice recognition is based upon a comparison of digital audio recordings (audio recordings of the voice links of a dictionary .ias and the audio recording of the voice command spoken by the user), voice recognition is very considerably simplified and made much more reliable, by comparison with recognition systems of the phonetic type such as the one implemented in U.S. Pat. No. 6,029,135. In addition, there is no longer any dependence on a particular language.

After recognition of a voice link, the voice recognition programme sends the navigator (B) (step 804) the action that is associated with this voice link and that is encoded in the dictionary, i.e., in the particular example previously described, the URL address of this voice link.

If the associated action corresponds to the loading and display of a new page identified by its URL address, the navigator (B), before the appropriate request is sent to the server, unloads the page being displayed (page(m).htm) as well as the extension module that is associated therewith, which extension module, prior to unloading, interrupts the link established between the voice recognition program (E) and dictionary file page(m).ias. Then, the steps of operation are resumed at the aforementioned step (701).

In the particular exemplary embodiment described, each voice link is characterised by an address (URL), which is communicated to the navigator of the client device when this voice link has been recognised by the voice recognition program, which then enables the navigator to dialogue with the server in order for the latter to send the client device the resource corresponding to this address and, for example, a new page. The invention is not, however, limited thereto. The use of this “address” attribute of a voice link can be generalised to encode in a general manner the action that is associated with the voice command defined by the voice link, and which must be automatically executed upon automatic recognition of a voice link by the voice recognition program. Thus, this action encoded in the “address” attribute can be not only an address locating a resource stored on server 1 but could also be an address locating a resource (data, executable program, etc.) stored locally at client device 2, or a code commanding an action executable by the client device, such as, for example, and non-limitatively, the commanding of a peripheral locally at the client device (printing a document, opening or closing a window on the screen of the client device, ending communication with the server and, possibly, setting up communication with a new server the address of which was specified in the “address” attribute, final disconnection of the client device from telecommunications network 3, etc.).

1. System for the voice control of a page intended to be displayed on a client device which, on one hand, can exchange data with a remote server via a telecommunications network and which, on the other hand, includes means permitting the recording of a voice command spoken by a user, and voice recognition means making it possible, from a recorded voice command, to determine and command automatically the execution of an action associated with this voice command, characterised in that the server has in its memory, in association with said page, at least one dictionary of one or more voice links including for each voice link at least one audio recording of the voice command, in that the client device is capable of downloading into its memory each dictionary associated with the page, and in that the voice recognition means of the client device comprise a voice recognition program that is designed to make a comparison of the audio recording corresponding to the voice command with the audio recording or recordings of each dictionary associated with the page.

2. System according to claim 1, characterised in that a voice link comprises several audio recordings of the voice command, including at least one recording of a female voice and one recording of a male voice.

3. System according to claim 1, characterised in that the page of the server comprises an item of information identifying the associated dictionary or dictionaries, and in that the client device is designed, on one hand, to detect this information at the time the page is displayed and, on the other hand, in the event of detection of this information, to send a request to the server in order for the latter to send it the dictionary identified by this item of information.

4. System according to one of claims 1 to 3, characterised in that each voice link of a dictionary comprises an address enabling a resource to be located.

5. System according to claim 1, characterised in that each voice link of a dictionary comprises a name of the voice command, and in that the client device is designed, after reception of a dictionary, to read and display the names of all or part of the voice links of this dictionary.

6. System according to claim 5, characterised in that each voice link in a dictionary comprises an attribute (“type”) making it possible to specify whether a voice command is to be hidden or not, and in that the client device is designed, after the reception of a dictionary, to read and display the names only of the voice links of which the value of the “type”attribute authorises the display.

7. Data server comprising a processing unit and a memory unit which is at least read-accessible by the processing unit, and in which are stored a plurality of pages intended to be displayed on a client device after downloading via a telecommunications network, characterised in that the memory unit comprises, linked with each page, at least one dictionary of one or more voice links, with each voice link comprising at least one audio recording of a voice command.

8. Server according to claim 7, characterised in that each page of the server comprises an item of information identifying the associated dictionary or dictionaries.

9. Server according to claim 7 or 8, characterised in that each voice link comprises an address enabling a resource to be located, preferably in the memory unit of the server.

10. Client device which, on one hand, is capable of exchanging data with a remote server and of downloading and displaying pages of data stored in the memory of the server and which, on the other hand, includes means permitting the recording of a voice command spoken by a user, and voice recognition means making it possible, from a recorded voice command, to determine and command automatically the execution of an action associated with this command, characterised in that the client device is designed to download into its memory from the server a dictionary that is associated with a page displayed and that contains one or more voice links, each voice link including at least one audio recording of a voice command, and in that the voice recognition means of the client device comprise a voice recognition program which is designed to effect a comparison between the audio recording corresponding to the voice command spoken by a user with the audio recording or recordings of each dictionary that has been downloaded.

11. Memory medium readable by a client device and on which is stored a page that is displayable on the client device and which comprises a plurality of instructions readable by the client device, the instructions representing the contents of the page and including an item of information that identifies at least one dictionary associated with the page, said dictionary including one or more voice links, a voice link including at least one audio recording of a voice command, said information, once it has been read by the client device, triggering the downloading of said dictionary from a remote server.
